(19) United States
(12) Patent Application Publication
(10) Pub. No.: US 2024/0174273 A1
(43) Pub. Date: May 30, 2024

(54) Methods and Systems for Implementing Drive Systems and Braking Systems on Railway Vehicles

(71) Applicant: Intramotev Inc., St. Louis, MO (US)

(72) Inventors: Timothy John Franklin Luchini, St. Louis, MO (US); Alexander James Peiffer, St. Louis, MO (US); Corey Michael Vasel, St. Louis, MO (US)

(21) Appl. No.: 18/519,858

(22) Filed: Nov. 27, 2023

Related U.S. Application Data
(60) Provisional application No. 63/385,322, filed on Nov. 29, 2022.

(51) Int. Cl. B61L 3/00; B60L 7/18; B60T 8/17; B61C 3/00

(52) U.S. Cl. CPC B61L 3/006; B60L 7/18; B60T 8/1705; B61C 3/00; B61L 3/008; B60T 2201/02; B60T 2270/60

(57) ABSTRACT

Example embodiments relate to implementing electromechanical drive systems and auxiliary braking systems on freight cars and other railway vehicles. Such motive systems can include electric motors and power sources that can be installed on new or existing non-locomotive railway vehicles to supplement and/or replace energy typically generated by one or more locomotives in the trainset. Some motive systems further include regenerative braking systems that can supplement existing braking systems and enable energy to be captured and stored locally at batteries onboard the railway vehicle for subsequent use by the drivetrain. A computing system may use sensor data from onboard sensors, route data, weather data, and/or other sources of information to determine and execute control strategies that leverage the drive system and auxiliary braking in ways that reduces the power required by locomotives and/or the stress impacting couplers between railway vehicles within the train.

### CROSS REFERENCE TO RELATED APPLICATION

The present application claims priority to U.S. Provisional Patent Application No. 63/385,322, filed on Nov. 29, 2022, all contents of which is herein incorporated by reference.

### FIELD

The present disclosure relates generally to rail transportation systems, and more particularly to electromechanical drive systems and auxiliary braking systems for railway vehicles.

### BACKGROUND

In rail transport, a train is a series of connected vehicles that run along a railway track and transport people or freight. Trains are typically pulled or pushed by one or multiple locomotives that generate motive force to propel a train toward a destination along the railway track. As such, passengers and cargo are carried in railway vehicles.

Railway vehicles include a variety of components that enable train movement along the railway track, including bogies, couplers, and brakes. Bogies, also sometimes referred to as trucks, provide support for the wheels and axles of the trains. Railway vehicles typically have two or more bogies, each of which may include two or more axles with wheels to enable maneuvering along curves and to support heavy loads. Additionally, couplers are used to link different railway vehicles within a train together and can include, for example, buffer and chain couplers or Janney couplers. Railway vehicles also utilize brakes to enable the entire train to slow down and stop. Such brakes are often used across multiple wheels on multiple railway vehicles to increase and distribute the available braking.

Trains typically use kinetic energy generated by large locomotive units positioned at the front of a train (a pull configuration), at the rear of a train (a push configuration), at both ends of a train (a push-pull configuration) and occasionally positioned between railway vehicles within the trainset (distributed propulsion). Conventionally, locomotives provide the tractive capability of the train. Factors that influence the power requirements of a train include the number of railway vehicles making up the train, the weight of the train, and gradients in the train's route, among other potential factors.

Most railway vehicles utilize braking systems that cause a frictional material (e.g., a brake pad) to clamp the wheels or discs of the railway vehicles. In some scenarios, the braking systems could include air brakes that utilize compressed air in a piston/cylinder configuration. These air brake systems are distributed along the length of the train. In some cases, the locomotive(s) may run its traction motors in reverse to remove kinetic energy from the train.

The freight rail industry is increasingly being pushed toward adopting new technology and improving service. Adoption of new technology within the existing 200+ year old model of rail transportation, however, can be challenging. Freight movement is still largely driven by traction motors positioned on locomotives that require large amounts of power generation, which limits drivetrain design options. Additionally, the majority of existing railway vehicles are built with traditional braking and wheelset structures, which might make extensive rework or replacement very costly. Thus, there is a need for solutions that can enhance the performance of railway vehicles and trains in general without the high costs associated with complete replacement of railway vehicles.

### SUMMARY

Example embodiments relate to techniques and systems for implementing electromechanical motive/drive systems and auxiliary braking systems on freight cars and other types of railway vehicles. Such motive systems can include electric motors and power sources that can supplement and/or replace energy typically generated by locomotives in a combination of coupled railway vehicles, which are commonly termed the trainset. Motive systems may also include one or more regenerative braking systems, which can supplement an existing braking system on the railway vehicle and enable energy to be captured and reused by the motive system. As such, a computing system may use sensor data from onboard sensors, external sources, route data, weather data, and/or other sources of information to determine and execute control processes that leverage the drive system and auxiliary braking system in ways that reduce the power required by locomotives and/or reduce the stress forces imparted on the couplers that connect railway vehicles within the trainset.

Accordingly, a first example embodiment describes a system for providing motive force to a drive axle of a vehicle. The system includes a drive motor, a drive sprocket attached to the drive axle, a transmission coupled between the drive motor and the drive axle, and an electrical power source coupled to an input of the driver motor. The drive motor is configured to convert electrical energy from the electrical power source into torque that causes rotation of the drive axle via the transmission coupled between the drive motor and the drive axle.

Another example embodiment describes a method. The method involves obtaining, by a computing system, sensor data from one or more sensors coupled to a railway vehicle. The method further involves controlling, by the computing system, a drive motor coupled to a railway vehicle based on the sensor data. The drive motor is configured to cause rotation of a drive axle of the railway vehicle via a transmission coupled between the drive motor and the drive axle.

In yet another example embodiment, a method of controlling a trainset including a plurality of railway vehicles connected via couplers is described. The method involves receiving information indicative of a track grade and controlling, based on the track grade, an electrical motive system of one or more of the railway vehicles to adjust a torque imparted on a respective drivetrain so as to minimize intercoupler forces on the couplers.

An additional example embodiment describes a non-transitory computer-readable medium configured to store instructions, that when executed by a computing device, causes the computing device to perform operations corresponding to the methods above.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a motive system for a railway vehicle, according to one or more example embodiments.

FIG. 2 is a functional block diagram illustrating a computing device, according to one or more example embodiments.

FIG. 3 is a configuration of a railway vehicle with a motive system, according to one or more example embodiments.

FIG. 4 is another configuration of a railway vehicle with a motive system, according to one or more example embodiments.

FIG. 5 is an additional configuration of a railway vehicle with a motive system, according to one or more example embodiments.

FIG. 6A depicts a perspective view of a motive system with an electric motor, according to one or more example embodiments.

FIG. 6B shows another perspective of the motive system shown in FIG. 6, according to one or more example embodiments.

FIG. 6C shows a motive system with an electric motor mount, according to one or more example embodiments.

FIG. 6D shows the motive system shown in FIG. 6C, according to one or more example embodiments.

FIG. 7A illustrates an auxiliary braking system for a railway vehicle, according to one or more example embodiments.

FIG. 7B illustrates a side view of the braking system shown in FIG. 7A, according to one or more example embodiments.

FIG. 7C illustrates an end view of the braking system shown in FIG. 7A and FIG. 7B, according to one or more example embodiments.

FIG. 7D illustrates a close-up view of the braking system shown in FIGS. 7A-FIG. 7C, according to one or more example embodiments.

FIG. 7E illustrates another close-up view of the braking system shown in FIGS. 7A-FIG. 7D, according to one or more example embodiments.

FIG. 8 is a flowchart of a method for operating a motive system installed on a railway vehicle, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Example embodiments presented herein relate to techniques for implementing motive systems on new or existing payload railway vehicles. Such motive systems can be used to increase the performance of trains while also decreasing (or eliminating) the energy consumption required from locomotives driving the trains. In some cases, a railway vehicle can be controlled independently via a motive system without the need of a locomotive. By adding motive systems onto railway vehicles, the railway vehicles can be used safely to perform different types of operations that might not have been available previously due to the need of a locomotive.

By way of an example, a motive system may be installed via modifications to an existing freight vehicle or another type of railway vehicle that incorporate one or multiple electromechanical drive systems that can supplement and/or replace motive energy supplied by one or more locomotives. An electromechanical drive system can include one or multiple electric motors that are coupled to the axle of the railway vehicle, which enables the motors to be used to rotate the wheels of the railway vehicle in both directions at various speeds. In addition to the motors, the electromechanical drive system may also incorporate batteries and/or other sources of electrical energy located onboard the railway vehicle. These power sources can be used by the motors to supplement and/or replace motive energy typically generated by locomotives for a train.

In some examples, a motive system can also involve adding one or multiple supplementary braking systems onto a railway vehicle to replace and/or supplement existing braking systems used by the railway vehicle. For example, the motive system can include a regenerative braking system, which can capture and convert energy generated during braking applications into stored energy for subsequent use by a connected drive system (e.g., one or more motors). This way, individual railway vehicles modified with a motive system can have and use an electrical drive system that is independent of any locomotives along with a supplemental energy source that can used and recharged during routes performed by the vehicles. In some examples, motive systems presented herein can include and use other types of energy sources, such as solar panels, petroleum based sources, flywheels, and/or capacitors, among others.

A motive system can be controlled and operated via one or multiple computing systems, which can be positioned onboard the railway vehicle, on another railway vehicle, and/or remote from the railway vehicle. For example, each railway vehicle equipped with a motive system may include a computing system with these computing systems able to communicate with each other to coordinate actions among different vehicles throughout the train during a route. In addition, computing systems can also be positioned remotely from the railway vehicles and can communicate with various sources, such as onboard sensors, databases, route planners, other trains, and local stations, among others. The communication technologies used between components and computing systems can differ within example embodiments.

The computing systems operating as parts of motive systems can perform various operations to enhance the performance of individual railway vehicles as well as the train overall. For instance, a computing system may use sensor data and/or other information to control the applications of drive systems and/or braking systems on railway vehicles in a manner that reduces the power required by locomotives associated with the train and/or the stress forces imparted on couplers that connect railway vehicles.

By way of an example, a railway vehicle can include, or may be modified to include, an electric drive system that can propel one or multiple wheelsets on the railway vehicle. For instance, the electric drive system may include multiple electric motors that can use electric energy from batteries or another electrical power source positioned on the railway vehicle (or energy from another source) to generate torque that can rotate the wheels on the railway vehicles. The batteries can be part of a battery storage system, which may be used exclusively by the electric drive system or shared by other components (e.g., components of the train). A computing system may supply control instructions to one or multiple motors on one or more railway vehicles to enhance the performance of the train containing the railway vehicles. For example, the computing system may use one or more electric drive systems to supplement and/or replace kinetic energy supplied by one or more locomotives in the trains. The computing system can use one or multiple electric drivetrains to supply kinetic force when the train is traveling uphill, to maintain proper spacing between railway vehicles and reduce stress on couplers, and/or when batteries onboard have sufficient energy available, among other factors.

In some instances, the computing system can obtain and use sensor information, control instructions, route information, weather data, signals from other railway vehicles and/or locomotives, and/or other sources of information to determine control strategies for using the drive systems and braking systems in ways that improve operations of the train. For instance, the computing system may initiate regenerative braking applications when battery levels are low and/or during particular portions of a route, such as during particular changes in gradients (e.g., downhill). In addition, in some examples, railway vehicles may include electric drive systems and braking systems that enable the railway vehicles to operate independently without locomotives. For instance, railway vehicles can include control systems in addition to electric drive systems that enable the railway vehicles to increase and decrease speeds and handling as the railway vehicle traverses along a railway.

Motive systems and regenerative braking can be leveraged on railway vehicles to enhance performance during travel on a route. For instance, a computing system may coordinate the movements of multiple railway vehicles to remove forces that arise during travel within a trainset, thereby reducing shock and other negative forces. In addition, when a trainset includes multiple railway vehicles equipped with motive systems, the trainset can adjust which railway vehicle or vehicles are supplying motive force at any given time along a route.

In some examples, a computing system may use an installed motive system to enhance stopping a trainset, which may involve using one or multiple drive trains installed on railway vehicles within the train set. For instance, the computing system can cause motors to cause torque in a direction opposite of the current direction of travel to help decrease the speed of the overall trainset. In addition, the computing system may use auxiliary braking systems installed on one or more railway vehicles within the trainset to decrease the distance needed to stop the trainset.

In some cases, the auxiliary braking systems may be regenerative braking systems that can charge batteries positioned onboard one or more railway vehicles. For instance, the regenerative braking system can be connected to a battery storage system located on a railway vehicle. The braking system onboard one or multiple railway vehicles, for example, may be regenerative brakes or feed resistive heater banks to diffuse the residual energy with or without available batteries. In some cases, if a railway vehicle is equipped with batteries that reach a fully charged state, the resistive heat banks can be used for the additional power.

A motive system can be used on railway vehicles for coupling and decoupling. The motive system allows for the adjustment of speeds, enabling the vehicles to approach each other closely for coupling or move apart during decoupling. A computing system is involved in this process, utilizing sensor data to precisely locate couplers and control motors for a gradual and safe connection. Various sensors, such as cameras and ultrasonic sensors, are employed on the railway vehicles to facilitate accurate movements relative to other vehicles during coupling or decoupling. The motive system can play a role in minimizing intercoupler forces within a trainset consisting of multiple connected railway vehicles. Techniques may involve adjusting the speed of specific vehicles to optimize performance and reduce intercoupler forces. The computing system takes into account factors such as track grade and other parameters when determining how to minimize these forces. Example motive systems can leverage technology and sensors to enhance the coupling and decoupling processes in railway vehicles, with a focus on safety and performance optimization.

### I. Example Systems

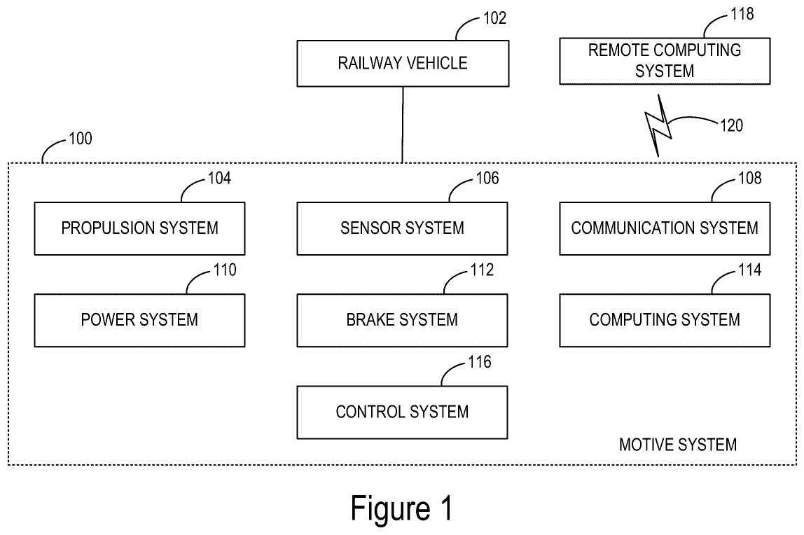

Referring now to the figures, FIG. 1 is a functional block diagram illustrating an example motive system 100 that can be implemented on railway vehicle 102 and configured to perform disclosed operations. In the example embodiment, motive system 100 may include various subsystems, such as propulsion system 104, sensor system 106, communication system 108, power system 110, brake system 112, computing system 114, and control system 116. In other examples, motive system 100 may include more or fewer subsystems. In addition, the subsystems and other components of motive system 100 can be interconnected via wired or wireless connections and operations performed by motive system 100 can be divided into additional functional or physical components and/or combined into fewer functional or physical components within examples.

Railway vehicle 102 represents any type of vehicle that can transport people and/or cargo on a railway. In some examples, railway vehicle 102 may be a freight car or a flatcar configured to move materials or other types of materials. In particular, railway vehicle 102 is a burdened rail vehicle in some embodiments. Traditional locomotives are unburdened (i.e., not carrying payload) whereas traditional freight railcars are unpowered and serve to carry payloads similar to trailers as burdened vehicles. As such, the size, shape, and configuration of railway vehicle 102 can differ within examples. In addition, the number and types of axles and wheels positioned onboard the railway vehicle 102 can vary. Generally, railway vehicle 102 may include two axles per truck with two trucks per railcar. Railway vehicle 102 may include one or multiple types of couplers that enable railway vehicle 102 to be coupled to other railway vehicles.

Motive system 100 may include propulsion system 104 in some examples. As such, propulsion system 104 may include one or multiple components configured to supply powered motion for railway vehicle 102. For instance, propulsion system 104 may include one or multiple motors that can use power from power system 110 to generate torque to rotate wheels of railway vehicle 102. In some embodiments, propulsion system 104 may include multiple types of engines and/or motors.

Sensor system 106 may include one or multiple types of sensors that can be used to enhance the performance of railway vehicle 102. Generally, sensor system 106 can be utilized to understand the environment of railway vehicle 102, the performance of components of railway vehicle 102, and enable tailoring performance of railway vehicle 102 towards the environment. For instance, sensor system 106 may include one or more radars, lidars, cameras, wind sensors, force sensors, contact sensors, precipitation sensors, light sensors, humidity sensors, strain gauges, thermal imaging, radio navigation units, encoders, resolvers, laser range finding sensors, RFID sensors, gyroscopes and/or magnetometers, accelerometers, magnetic sensors, microphones, strain and weight sensors, Global Positioning Systems (GPS), inertial measurement units (IMUs), passive infrared sensors, ultrasonic sensors, wheel speed sensors, and/or throttle/brake sensors, among other possibilities. Sensor system 106 may also include one or multiple sensors configured to monitor existing components of railway vehicle 102.

Various sensors from sensor system 106 can be placed on different components of railway vehicle 102. For instance, some sensors can be positioned on couplers while others are housed in a particular container positioned near a front or a rear end of railway vehicle 102. Some sensors can measure aspects of couplers positioned on railway vehicle 102. For instance, these sensors can indicate the stress level on couplers, among other information.

In some examples, sensor system 106 may include one or multiple sensors that can detect waypoints positioned along a railway track. Sensor system 106 may also enable railway vehicle 102 to triangulate its position relative to offboard radio stations and/or other sources of communication signals, such as 4G or 5G towers. Sensor system 106 can also be used to weigh railway vehicle 102 and adjust performance of electric motors and/or other components located onboard the railway vehicle 102.

In some examples, a motor encoder and/or solver data can be used to detect wheel slipping on railway vehicle 102 due to wet, icy, or debris laden tracks. In response, computing system 114 may then implement effective control strategies. Onboard sensors can be used to detect vandals in some embodiments. Computing system 114 may use cameras and radar to detect potential vandalism and responsively transmit signals to a user and/or authorities to protect cargo and payloads via communication system 108. In addition, sensor system 106 can be used for automated track inspections and to determine rail condition. In some cases, computing system 114 may determine deviation from normal rail characteristics based on sensor data data from sensor system 106. For instance, computing system 114 may detect railcar hunting, vibration, and/or other dynamics based on sensor data.

As further shown in FIG. 1, motive system 100 may include communication system 108, which may be used to communicate with one or more devices (e.g., remote computing system 118) directly or via a communication network (e.g., wireless connection 120). In some examples, communication system 108 may include one or multiple dedicated short-range communications (DSRC) devices that could include public and/or private data communications with stations positioned near tracks.

Power system 110 may include one or multiple power sources that can supply power to different components of motive system 100 and/or railway vehicle 102. For instance, power system 110 may include batteries, petroleum-based fuels, gas-based fuels, solar panels, among other types of power generation sources. In some example embodiments, power system 110 may include a combination of batteries, capacitors, and/or flywheels. In some cases, power system 110 may be shared across multiple railway vehicles within a trainset. For instance, direct electrical connections can exist between power systems on different railway vehicles. In addition, multiple power systems can be used to share energy in optimal ways, such as using an overcharged battery pack to kinetically recharge a depleted or lower state of charge battery pack.

Brake system 112 may represent one or multiple supplementary brake systems that motive system 100 may include to further enhance performance of railway vehicle 102. For instance, brake system 112 is a regenerative brake system in some embodiments. As a regenerative system, brake system 112 can serve as an energy recovery mechanism that also slows down the railway vehicle by converting its kinetic energy into a form that can be used immediately or stored until needed. For instance, brake system 112 can convert kinetic energy into energy stored by one or more batteries of power system 110. In some instances, brake system 112 can dissipate the energy as heat, such as when the battery storage that is located onboard the railway vehicle 102 is full.

In some embodiments, brake system 112 can be a regenerative braking system that can be used to feed electricity directly into the electrical grid through overhead catenary lines or other technologies (e.g., third rails used for power). Brake system 112 can also be used during short sections of track without requiring full electrification of the track lines to take advantage of traditional unelectrified rail as well as short electrified sections for recharging and returning power to the grid.

Computing system 114 represents one or multiple computing devices that can perform operations, such as the various operations described herein. Computing system 114 may include one or multiple processors that can execute instructions stored in a non-transitory computer readable medium (e.g., data storage). The instructions can enable computing system 114 to operate with the various subsystems of motive system 100 and other computing devices (e.g., remote computing system 118). In some examples, motive system 100 may use communication system 108 to communicate with remote computing system 118 over a wireless connection 120. In addition, computing system 114 may include one or multiple user interface elements to enable users to provide instructions and/or receive information from motive system 100. For instance, computing system 114 may include one or more input/output devices, such as a touchscreen, speaker, and microphone, etc.

In some embodiments, computing system 114 is designed to be self-redundant in order to offer duplex or triplex redundancy in case of a partial system failure. This allows for computing system 114 to continue operations in case of a failure as well as to have a redundant system verifying and validating sensor inputs received from sensor system 106.

Control system 116 can include one or multiple components designed to assist in the operations of railway vehicle 102. For instance, control system 116 can include components that enable control of other components of motive system 100.

Remote computing system 118 represents a computing system that may provide information and/or control instructions to motive system 100 and/or railway vehicle 102. For instance, remote computing system 118 may be a smartphone, server, laptop, and/or another type of device that enables inputs to different components within motive system 100.

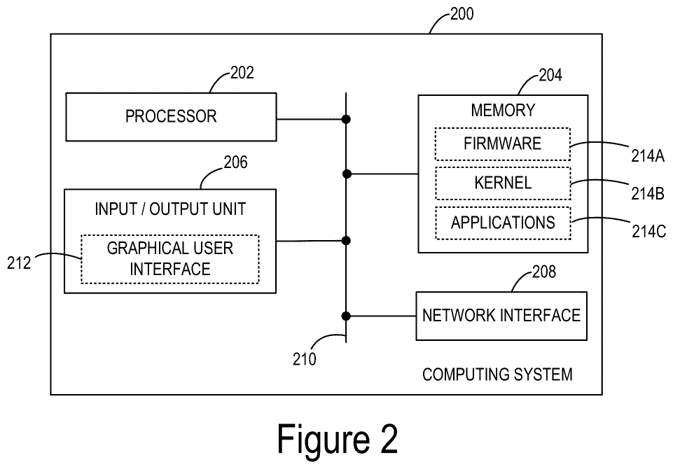

FIG. 2 is a block diagram of computing system 200, illustrating some of the components that could be included in a computing device arranged to operate in accordance with the embodiments herein. As such, computing system 200 may be implemented as computing system 114 of motive system 100 and/or remote computing system 118 shown in FIG. 1.

In the example embodiment shown in FIG. 2, computing system 200 includes processor 202, memory 204, input/output unit 206, and network interface 208, all of which may be coupled by a system bus 210 or a similar mechanism. In some example embodiments, computing system 200 may include other components and/or peripheral devices (e.g., detachable storage and/or sensors).

Processor 202 may be one or more of any type of computer processing element, such as a central processing unit (CPU), a co-processor (e.g., a graphics processor), a digital signal processor (DSP), a network processor, and/or a form of integrated circuit or controller that performs processor operations. As such, processor 202 may be one or more single-core processors and/or one or more multi-core processors with multiple independent processing units. In addition, processor 202 may also include register memory for temporarily storing instructions being executed and related data, as well as cache memory for temporarily storing recently-used instructions and data.

Memory 204 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples. Computing system 200 may include fixed memory as well as one or more removable memory units, the latter including but not limited to various types of secure digital (SD) cards. As an example result, memory 204 can represent both main memory units as well as long-term storage. Memory 204 may store program instructions and/or data on which program instructions may operate. By way of example, memory 204 may store these program instructions on a non-transitory, computer-readable medium, such that the instructions are executable by processor 202 to perform any of the methods, processes, or operations disclosed in this specification or the accompanying drawings.

As shown in FIG. 2, memory 204 may include firmware 214A, kernel 214B, and/or applications 214C. Firmware 214A may be program code used to boot or otherwise initiate some or all of computing system 200. Kernel 214B may be an operating system, including modules for memory management, scheduling and management of processes, input/output, and communication. In addition, kernel 214B may also include device drivers that allow the operating system to communicate with the hardware modules (e.g., memory units, networking interfaces, ports, and busses) of computing system 200. Applications 214C may be one or more user-space software programs, such as web browsers or email clients, as well as any software libraries used by these programs. In some examples, applications 214C may include one or more neural network applications and other deep learning-based applications. Memory 204 may also store data used by these and other programs and applications.

Input/output unit 206 may facilitate user and peripheral device interaction with computing system 200, sensors, and/or other computing systems, such as computing systems on other railway vehicles and/or positioned remote from a train. Input/output unit 206 may include one or more types of input devices, such as a keyboard, a mouse, one or more touch screens, sensors, biometric sensors, and so on. Similarly, input/output unit 206 may include one or more types of output devices, such as a screen, monitor, printer, speakers, and/or one or more light emitting diodes (LEDs). Additionally or alternatively, computing system 200 may communicate with other devices using a universal serial bus (USB) or high-definition multimedia interface (HDMI) port interface, for example. In some examples, input/output unit 206 can be configured to receive data from other devices. For instance, input/output unit 206 may receive sensor data from sensors, such as sensors positioned on a railway vehicle. As shown in FIG. 2, input/output unit 206 includes GUI 212, which can be configured to provide information to a user. GUI 212 may involve one or more display interfaces, or another type of mechanism for conveying information and receiving inputs. Some common rail techniques can involve signal lighting, horns, and bells, which can be implemented via input/output unit 206. With many techniques in traditional rail being visual and auditory in nature, these techniques in addition to more advanced signaling and human machine interfaces can be implemented.

Network interface 208 may take the form of one or more wireline interfaces (e.g., Ethernet) and/or enable communication over one or more wireless interfaces, such as IEEE 802.11 (Wi-Fi), BLUETOOTH®, GPS, 3G, 4G, 5G, or a wide-area wireless interface. In addition, other forms of physical layer interfaces and other types of standard or proprietary communication protocols may be used over network interface 208.

### II. Example Railway Vehicle Configurations

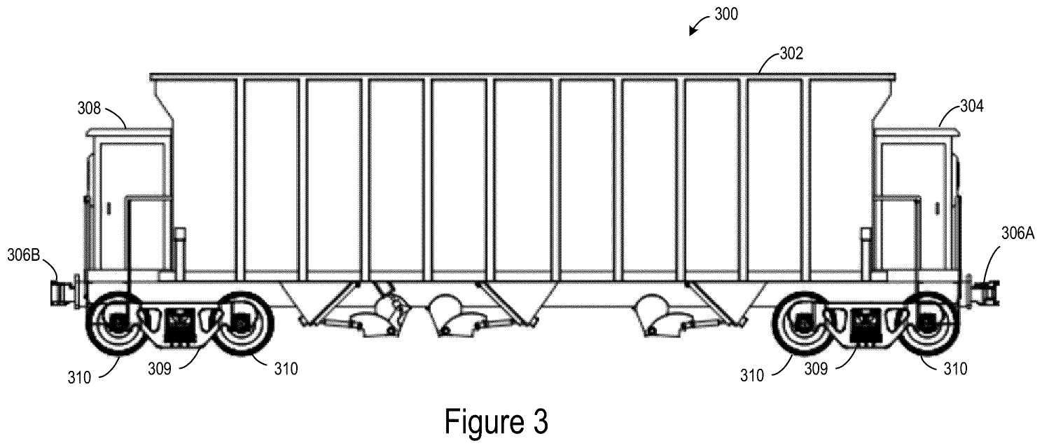

FIG. 3 illustrates a configuration of railway vehicle 302 equipped with motive system 300. In the example embodiment, motive system 300 is implemented on railway vehicle 302 and includes sensor system 304 positioned near front coupler 306A and battery storage 308 located near rear coupler 306B.

In the example embodiment, railway vehicle 302 is shown as a freight vehicle designed to carry materials and other cargo between locations. As shown, railway vehicle 302 includes bogies 309 (or trucks) that enable movement on wheels 310. As such, motive system 300 can involve installation of one or multiple components (e.g., electric motors, braking systems) on bogies 309 and other components of railway vehicle 302. Railway vehicle 302 can have alternative configurations within other embodiments. In addition, railway vehicle 302 can be part of a train that includes one or multiple railway vehicles equipped with motive systems 300.

Motive system 300 can be implemented as motive system 100 shown in FIG. 1 and can include one or more electric drive systems and an auxiliary braking system that can enable motive system 300 to perform operations disclosed herein that can enhance overall performance of railway vehicle 302. For instance, motive system 300 may include one or multiple electric drivetrains that can be used to turn axles connected to wheels 310. In addition, motive system 300 may also include a regenerative braking system that can be used to convert energy from one or more axles and/or wheels 310 and deliver energy to battery storage 308 during braking applications.

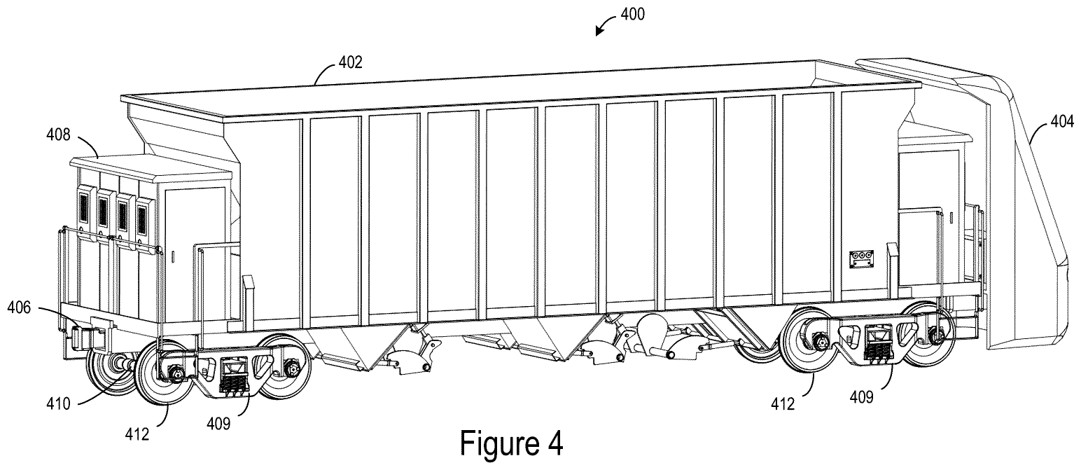

FIG. 4 illustrates another configuration of railway vehicle 402 configured with motive system 400, which can similarly include components of motive system 100 shown in FIG. 1 and may enable railway vehicle 402 to operate autonomously and without locomotives.

Railway vehicle 402 is similar to railway vehicle 302 shown in FIG. 3, but differs at the front end of railway vehicle 402. In particular, motive system 400 implemented on railway vehicle 402 includes sensor component 404 that may include additional sensors (e.g., cameras, radar) to enable railway vehicle 402 to perform operations typically completed by a locomotive. Railway vehicle 402 includes coupler 406 and bogies 409 configured with axles 410 and wheels 412 as shown in FIG. 4. In general, bogies 409 can be used to position motors and/or other components that enable railway vehicle 402 to be self-propelled. In some examples, regenerative braking components can be attached to axles 410, bogies 409, and/or wheels 412. In addition, housing 408 may include batteries and/or other components for motive system 400.

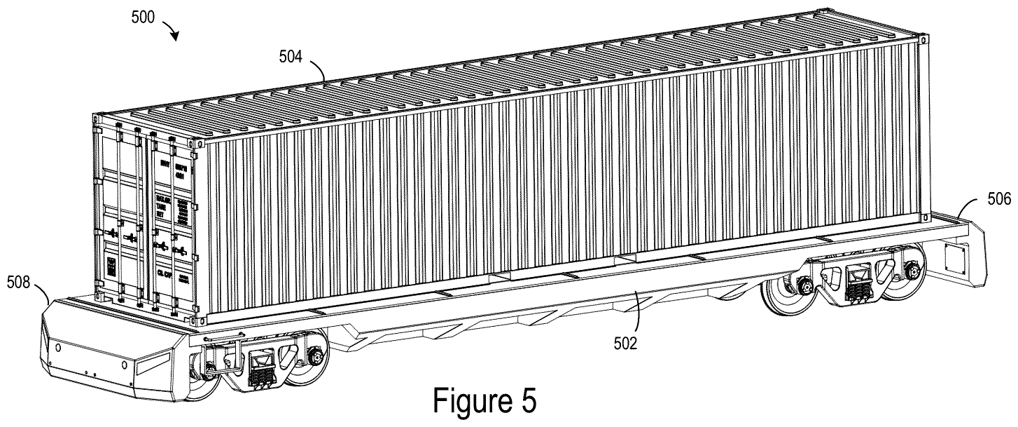

FIG. 5 illustrates an additional configuration of railway vehicle 502 configured with motive system 500. Similar to the examples shown in FIG. 3 and FIG. 4, motive system 500 can include components that can enhance performance of railway vehicle 502.

In the example embodiment, railway vehicle 502 has a flat design to enable one or multiple containers (e.g., shipping container 504) to be positioned on top. Motive system 500 implemented on railway vehicle 502 includes front component 506 and rear component 508. One or both of front component 506 and rear component 508 can include various components of motive system 500, such as sensors, energy storage (e.g., batteries), etc. In addition, the bogies of railway vehicle 502 can similarly include components of motive system 500, such as regenerative brakes, motors, etc. Motive system 500 can also be designed for standard coupling interfaces.

### III. Example Motive Systems

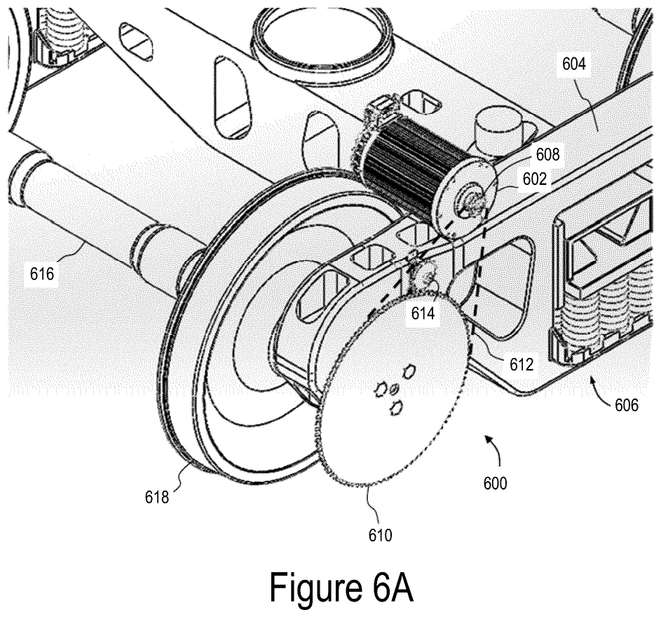

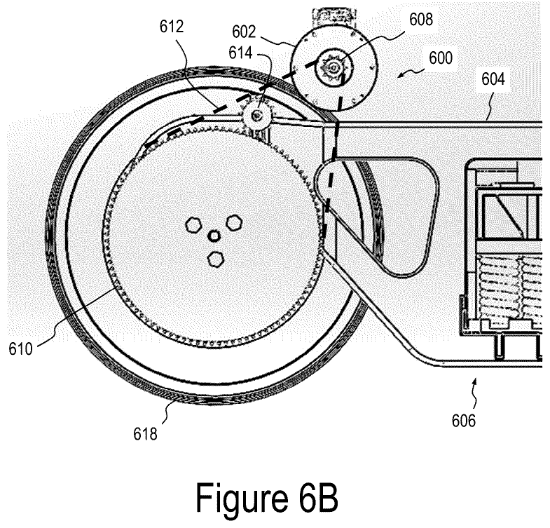

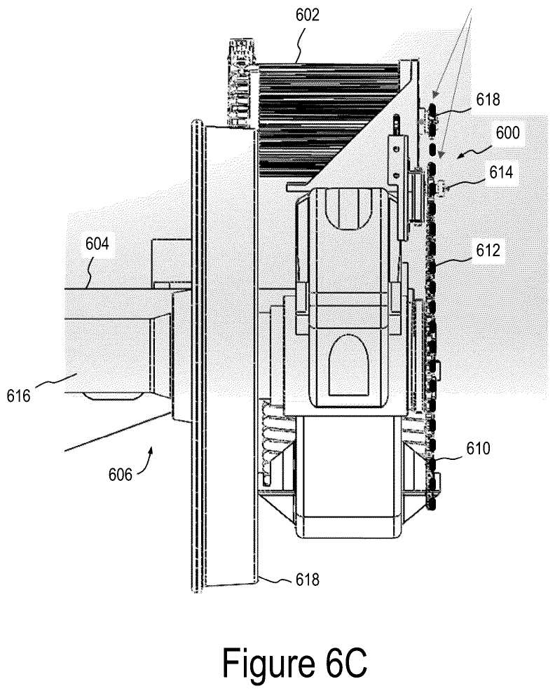

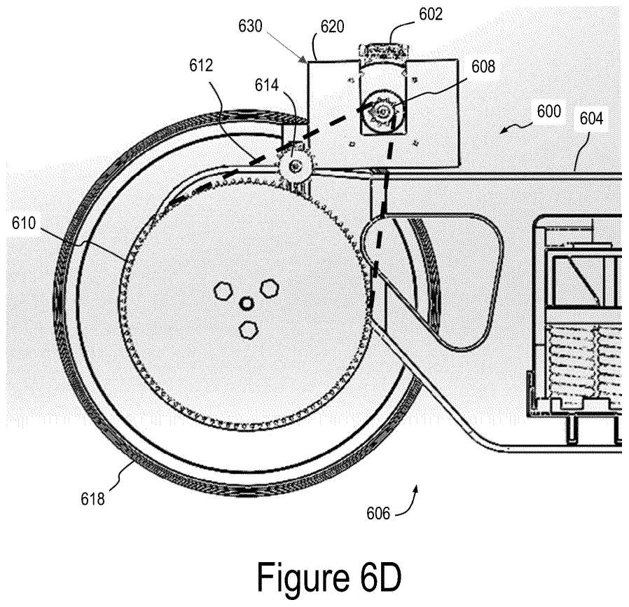

FIG. 6A, FIG. 6B, FIG. 6C, and FIG. 6D illustrate different views of drivetrain systems within motive system 600 that can be positioned on rail transportation equipment. FIGS. 6A-FIG. 6D represent different views and configurations that can be used when implementing drivetrains onto existing or new railway vehicles. In some examples, motive system 600 may be implemented similar to motive system 100 shown in FIG. 1. In addition, the railway vehicles can resemble railway vehicle 302 shown in FIG. 3, railway vehicle 402 shown in FIG. 4, or railway vehicle 502 shown in FIG. 5 in some examples.

In the example embodiment, motive system 600 includes motor 602, which is shown mounted to bolster frame 604 of bogie 606 and can correspond to an electric motor or another type of motor. A standard railway vehicle typically includes two bogies generally located near the ends of the vehicle with each bogie being a 2-wheeled, 4-wheeled, or 6-wheeled truck that can provide support to the vehicle body. As such, bogie 606 supports the mass of the railway vehicle and uses wheels 618 coupled to axle 616 to enable the railway vehicle to travel along the track and provide some degree of cushioning against the shocks transmitted from the track during motion.

As shown in FIGS. 6A-6D, output sprocket 608 of motor 602 is coupled to drive sprocket 610 via transmission 612. Motor 602 can be one or multiple motors in some examples and can include electric motors. For instance, motor 602 can be an AC brushless motor, DC brushed motor, DC brushless motor, linear motor, servo motor, or stepper motor, among others. In the example embodiment, transmission 612 is shown as a chain. In other examples, transmission 612 can involve gears or other components. For example, transmission 612 can include a gear drive. A gear drive is a mechanical transmission device that can use gears to transmit power and motion between two or more rotating shafts. Gears are toothed wheels that mesh with each other to transmit rotational motion and power. The primary purpose of a gear drive is to change the speed, torque, or direction of rotation between the input and output shafts. In some instances, motive system 600 may include tensioners 614 to maintain a desired amount of tension on transmission 612.

As further shown in FIGS. 6A-6D, Drive sprocket 610 is attached to axle 616 and allows for direct driving of one or more independent railway vehicle axles from one or both sides of the railway vehicle and on one or more axles. During operation of motive system 600, electrical energy is provided to motor 602, which causes output sprocket 608 to rotate. The rotational motion of output sprocket 608 is then transferred to drive sprocket 610 by transmission 612, thereby causing drive sprocket 610 to likewise rotate. Since drive sprocket 610 is attached to axle 616, axle 616 and wheels 618 attached thereto also rotate, providing motive power to bogie 606. As an example result, the connected railway vehicle may have kinetic motion supplied according to the direction of motor 602. As such, output sprocket 608 may be rotated clockwise or counter-clockwise and rotated at any desired speed and provide any desired amount of torque. Similarly, transmission 612 and the sizes of output sprocket 608 and drive sprocket 610 may be selected to deliver a desired amount of torque and rotational velocity to axle 616.

Axle 616 can be driven by motive system 600 positioned at the side of bolster frame 604. Alternatively, motive system 600 may be attached to an opposing side of bolster frame 604. In addition, a plurality of motive systems may be attached to opposing sides of bolster frame 604 and provide motive force to axle 616 from both opposing ends of the axle. Further, motive system 600 may be installed at either or both opposing ends of both of the axles 616 of bogie 606. The axle can be driven with a gear train of meshing gears with two or more gears in the gear train. The quantity of gears or sprockets used can depend on desired performance attributes from a given motive system. In particular, the quantity of gears can alter the gear ratio and change the size of the motor(s) required in some examples.

Axle 616 can be driven with a chain driven sprocket drive train with two or more sprockets and reducing sprockets in the drive train. The configuration of sprockets can reduce the force on a single point. The drive train can be driven with a combination of one or more gears and sprockets.

In some examples, motor 602 may involve multiple electric motors that can be powered down the length and across bogie 606, a single railway vehicle, or a complete trainset. This can be done to allow a single railway vehicle to achieve locomotion or to act as a distributed power unit in the length of a long train with a locomotive. In addition, the power for motor 602 may be provided by one or more sources such as, for example, electric power run from the locomotive, overhead catenary power lines, third electrified rail lines, onboard storage solutions like batteries and capacitors, or novel energy sources like hydrogen fuel cells or nuclear power plants.

In the case of electric batteries or capacitors, motor 602 can be run in reverse to brake the vehicle or to capture and utilize the generated electricity to recharge the electric storage unit. With minimal modifications to the structure of the standard freight equipment sufficient power can be provided directly through axles 616 by motive system 600 to power a trainset. The bogie frame can be modified to accept mechanical fastening of the motor and drivetrain mount hardware. Axle ends or axle caps can be modified to receive attachment of drive gear. Motor 602 can be coupled via motor mount 630 in some examples.

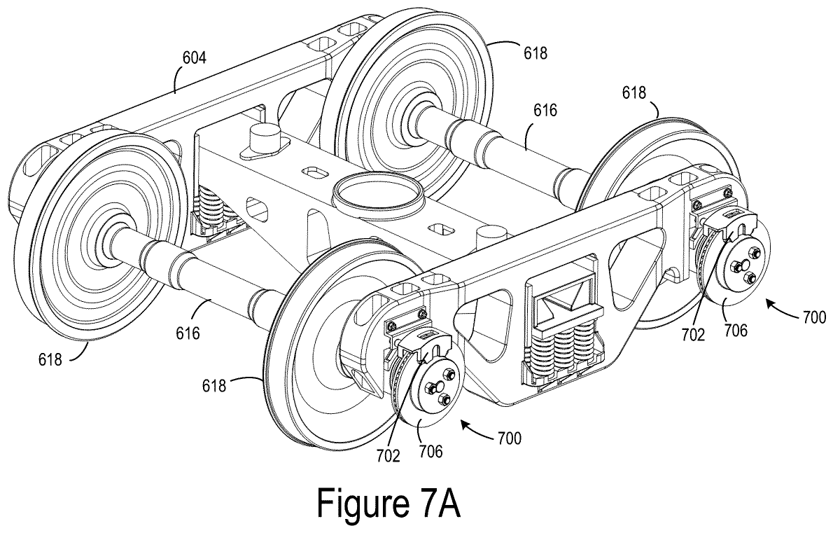

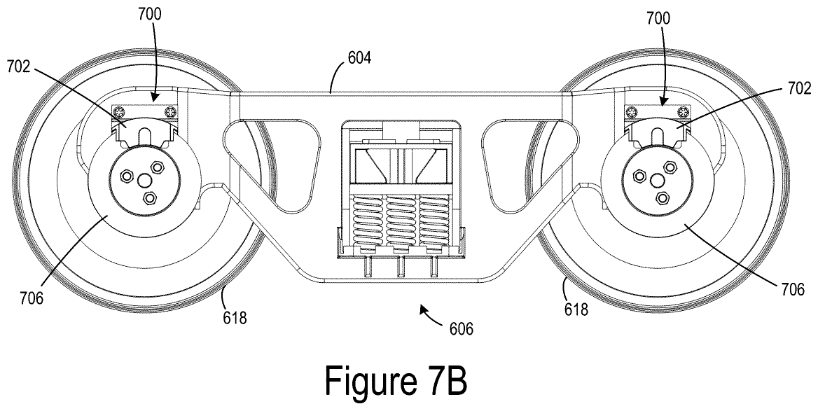

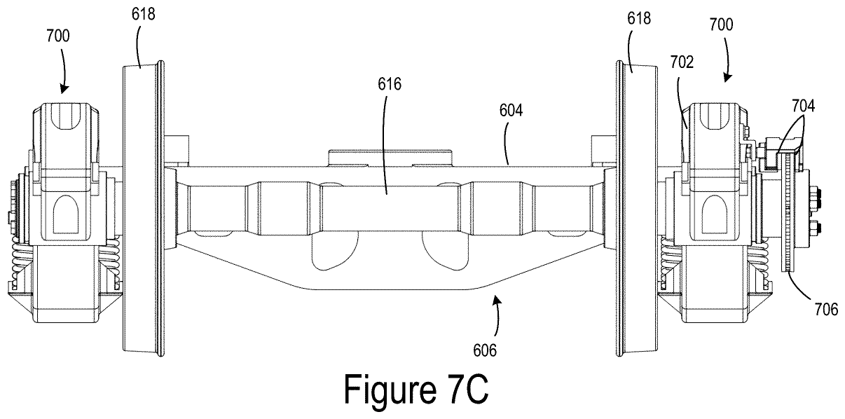

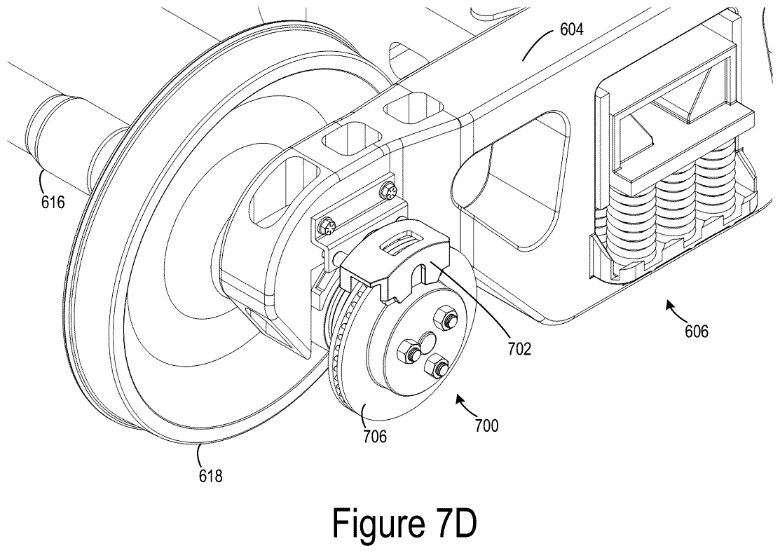

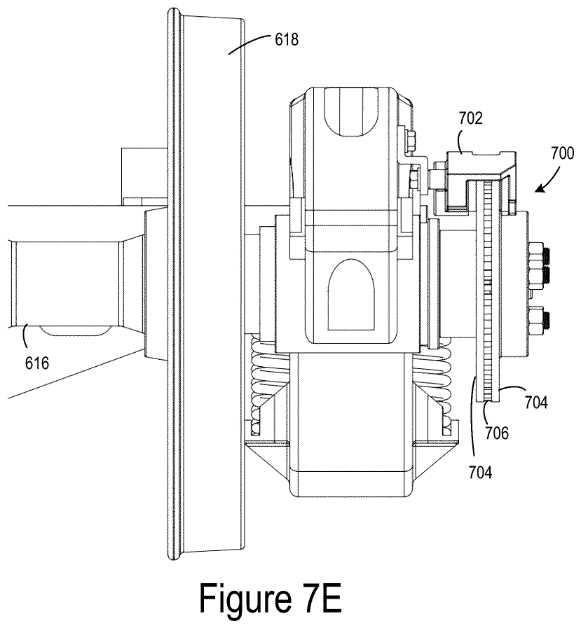

FIG. 7A, FIG. 7B, FIG. 7C, FIG. 7D, and FIG. 7E illustrate auxiliary braking system that can be implemented onboard a railway vehicle as part of motive system 600. In the example embodiment, braking system 700 is shown as an electric over hydraulic disk brake system and includes caliper 702, brake pad 704 and rotor 706. In particular, rotor 706 is mounted to axle 616 and caliper 702 is shown mounted to bolster frame 604. In some embodiments, the traditional air braking system is retained as part of the railway vehicle. In other embodiments, the traditional air braking system is removed and replaced by braking system 700.

Rotor 706 can be mounted directly through, over, replace, or under traditional axle caps with bolts 710. In addition, rotor 706 is shown mounted to axle 616, caliper 702 is mounted to bolster frame 604, and an electric over hydraulic pump and drive system is mounted upstream or on the bolster. Rotor 706 can be mounted directly through, over, replace, or under traditional axle caps with bolts 710 on an axle cap 712 handling the required shear loads to transfer braking force without inducing hardware failure. The traction system and braking system can be applied on the same axle within a bogie, on separate axles within a bogie, on separate bogies within a railway vehicle, or other combinations to achieve braking and traction drive for a rail vehicle.

Braking system 700 can be added to the left- or right-hand side of the bogie 606 truck set with the option to add them to both sides of axle 616 for increased stopping force. Braking system 700 can be added to one or more axles 616 with the option to run them on each bogie 16 truck set in a train consist, meaning braking power can be expanded up to every available axle on a train consist.

Brake pad 704 or caliper 702 can be actuated by hydraulic, pneumatic, or direct electric actuation driven from an electric over hydraulic, electric over pneumatic, direct pneumatic, or direct hydraulic system. The brake or caliper can also be actuated by direct electric actuators. These hydraulic actuators are self-contained pumping units which drive hydraulic or pneumatic pressure through hoses or brake lines to apply pressure to the brake calipers and pistons.

The disk brake can be slowed by electromagnetic braking of the spinning rotor and the corresponding generated electric fields, like a typical eddy current brake system.

The traditional airbrake system can remain unmodified for utilization as standard safety equipment or modified to be triggered independently or in conjunction with the added braking force of the electric motor in reverse and the added electric over hydraulic disk brakes. The traditional airbrake lines on a train remain and offer additional stopping power when actuated.

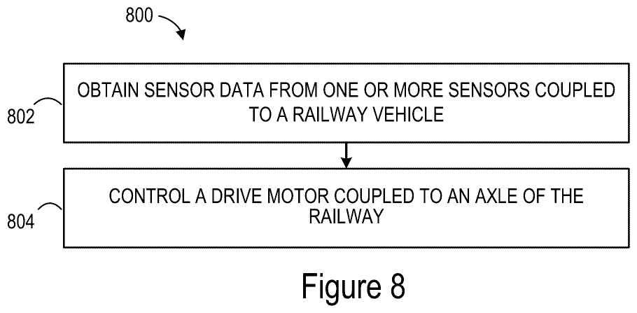

FIG. 8 is a flowchart of a method for operating a motive system installed on a railway vehicle. Method 800 represents an example method that may include one or more operations, functions, or actions, as depicted by one or more of blocks 802 and 804, each of which may be carried out by any of the systems, devices, and/or vehicles shown in FIGS. 1-5, FIGS. 6A-6D, and FIGS. 7A-7E, among other possible systems. For instance, computing system 200 depicted in FIG. 2 may perform method 800.

Those skilled in the art will understand that the flowchart described herein illustrates functionality and operations of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as may be understood by those reasonably skilled in the art.

At block 802, method 800 involves obtaining sensor data from one or more sensors coupled to a railway vehicle. For instance, a computing system onboard the railway vehicle and/or a remote computing system may receive sensor data from various sensors positioned on the railway vehicle.

In some examples, motive systems and the corresponding railway vehicles may integrate a diverse array of sensors to meticulously monitor their surroundings and uphold safe, efficient operations, such as cameras, lidar, GPS, radar, ultrasonic sensors, temperature sensors, IMUs, and load cells, among others. For instance, the motive system can use a GPS to precisely determine the location of the railway vehicle. This information is indispensable for navigation, tracking, and overseeing the train's speed and trajectory. Similarly, accelerometers may be used to measure the acceleration and deceleration of the railway vehicle. These sensors can be used by the computing system to detect alterations in speed and identify abrupt movements or shocks. In some cases, the computing system may also communicate with wheel slip sensors, which are designed to identify instances where train wheels slip, especially prevalent during adverse weather conditions or when traction is compromised.

In some examples, a motive system may include or communicate with an IMU that merges accelerometers and gyroscopes to capture both linear and angular motion. By providing data on the vehicle's orientation, tilt, and overall movement, the computing system may use sensor data from IMUs for stability control. The motive system can also communicate with one or more load cells, which can be used to measure the weight or load distribution on each axle of the railway vehicle. This information can be used by the computing system to ensure that the train adheres to safe weight limits and optimizing its overall performance. The computing system may also communicate with temperature sensors, which can be deployed to monitor railway vehicle components such as bearings, axles, and braking systems. Irregular temperature levels can serve as indicators of potential issues, prompting proactive maintenance measures. In some case, the computing system of a motive system can communicate with trackside sensors, including track circuits, which are strategically positioned along the railway track to detect the presence of trains, monitor their speed, and control signaling systems.

At block 804, method 800 involves controlling a drive motor coupled to a drive axle of the railway vehicle based on the sensor data. The drive motor is configured to cause rotation of the drive axle of the railway vehicle via a transmission coupled between the drive motor and the drive axle. For instance, the drive motor can covert torque into electrical energy that can be stored in the electrical power source.

In some examples, the computing system may receive, from an inertial measurement unit (IMU), sensor data representing changes in gradient along a route traveled by the railway vehicle and adjust a speed of the drive motor based on the sensor data representing changes in the gradient along the route traveled by the railway vehicle.

In some examples, the computing system may receive sensor data indicating a tension at a coupler of the railway vehicle. In particular, the coupler connects the railway vehicle to a second railway vehicle. As such, the computing system may control the drive motor based on the sensor data indicating the tension at the coupler.

In some examples, the computing system may receive information indicative of a track grade. For instance, the computing system may obtain information as pre-programmed route information or determined dynamically in route with local gyro, accelerometer, and/or GPS data. The computing system may then control, based on the track grade, an electrical motive system of one or more of the railway vehicles to adjust the torque imparted on a respective drivetrain so as to minimize intercoupler forces on the couplers.

In some examples, the computing system may cause a regenerative braking system to decrease rotation of the drive axle based on the sensor data. The regenerative braking system is coupled to an energy storage system located on the railway vehicle. The regenerative braking system positioned on a railway vehicle can operate by harnessing the kinetic energy generated during braking maneuvers. When a train applies its brakes, instead of dissipating the resulting kinetic energy as heat, regenerative braking activates electric generators or traction motors in the train's bogies. These motors, typically employed for propulsion, switch roles during braking, functioning as generators to convert the kinetic energy into electrical energy.

The regenerated electrical energy serves multiple purposes. It can be redirected back into the overhead power lines, especially in electrified railway systems, or stored in an onboard energy storage system, such as a battery or supercapacitor. Alternatively, the recaptured energy may be shared with other trains on the network or utilized to power onboard systems, contributing to a reduction in the overall energy consumption of the train. Regenerative braking not only enhances energy efficiency but also diminishes wear on traditional friction brakes, leading to decreased maintenance requirements and associated costs.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A system for providing motive force to a drive axle of a vehicle, comprising:
a drive motor;
a drive sprocket attached to the drive axle;
a transmission coupled between the drive motor and the drive axle; and
an electrical power source coupled to an input of the drive motor,
wherein the drive motor is configured to convert electrical energy from the electrical power source into torque that causes rotation of the drive axle via the transmission coupled between the drive motor and the drive axle.

2. The system of claim 1, further comprising:
a computing device configured to control a speed and a direction of the drive motor.

3. The system of claim 2, further comprising:
one or more sensors coupled to the vehicle, wherein the computing device is further configured to control the speed and the direction of the drive motor based on sensor data from the one or more sensors.

4. The system of claim 3, wherein the one or more sensors includes a sensor configured to obtain sensor data corresponding to a coupler coupled to the vehicle; and
wherein the computing device is configured to control the speed and the direction of the drive motor based on the sensor data corresponding to the coupler.

5. The system of claim 1, wherein the electrical power source corresponds to a battery storage system coupled to the vehicle, and
wherein the system further comprises:
a regenerative braking system configured to decrease rotation of the drive axle, wherein the regenerative braking system is further configured to transfer energy from decreasing rotation of the drive axle into the battery storage system.

6. The system of claim 1, wherein the transmission is a drive chain,
wherein a tensioner is coupled to the drive chain, and
wherein the tensioner is configured to increase an amount of tension on the drive chain.

7. The system of claim 1, wherein the transmission includes a gear drive.

8. The system of claim 7, further comprising:
a gear train of meshing gears with a plurality of gears.

9. The system of claim 1, wherein the transmission comprises:
a drive train with a plurality of sprockets and reducing sprockets.

10. The system of claim 1, wherein the vehicle is a railway vehicle configured to travel upon a railway track, and wherein the system is adapted to be retrofit to the railway vehicle.

11. The system of claim 1, wherein the drive motor is further configured to:
convert torque into electrical energy, wherein the electrical energy is stored in the electrical power source.

12. The system of claim 1, wherein the drive motor is coupled to a bogie of a railway vehicle.

13. A method comprising:
obtaining, by a computing system, sensor data from one or more sensors coupled to a railway vehicle; and
controlling, by the computing system, a drive motor coupled to a drive axle of the railway vehicle based on the sensor data, wherein the drive motor is configured to cause rotation of the drive axle of the railway vehicle via a transmission coupled between the drive motor and the drive axle.

14. The method of claim 13, further comprising:
receiving instructions from a remote computing system; and
wherein controlling the drive motor comprises:
controlling the drive motor based on the instructions and the sensor data.

15. The method of claim 13, wherein obtaining sensor data comprises:
receiving, from an inertial measurement unit (IMU), sensor data representing changes in gradient along a route traveled by the railway vehicle; and
wherein controlling the drive motor comprises:
adjusting a speed of the drive motor based on the sensor data representing changes in the gradient along the route traveled by the railway vehicle.

16. The method of claim 13, wherein obtaining sensor data comprises:
receiving sensor data indicating a tension at a coupler of the railway vehicle, wherein the coupler connects the railway vehicle to a second railway vehicle; and
wherein controlling the drive motor comprises:
controlling the drive motor based on the sensor data indicating the tension at the coupler.

17. The method of claim 13, further comprising:
based on the sensor data, causing a regenerative braking system to decrease rotation of the drive axle, wherein the regenerative braking system is coupled to an energy storage system positioned on the railway vehicle.

18. A method of controlling a trainset including a plurality of railway vehicles connected via couplers, the method comprising:
receiving information indicative of a track grade; and
controlling, based on the track grade, an electrical motive system of one or more of the railway vehicles to adjust a torque imparted on a respective drivetrain so as to minimize intercoupler forces on the couplers.

19. The method of claim 18, further comprising:
receiving information indicative of intercoupler forces imparted on the couplers; and
controlling, based on the intercoupler forces, an electrical motive system of one or more of the railway vehicles to reduce the intercoupler forces.

20. The method of claim 19, wherein controlling the electrical motive system of one or more of the railway vehicles comprises:
adjusting a speed of one or more railways vehicles to reduce a distance between the railway vehicles.
